(19) United States
(12) Patent Application Publication
(10) Pub. No.: US 2024/0134600 A1
(43) Pub. Date: Apr. 25, 2024

(54) FLOATING-POINT UNIT WITH A FUSED MULTIPLY-ADD (FMA) ENGINE FOR GENERATING BINARY INTEGER OUTPUT OR FLOATING POINT OUTPUT BASED ON A SELECTOR

(71) Applicant: INTERNATIONAL BUSINESS MACHINES CORPORATION, Armonk, NY (US)

(72) Inventors: Ankur AGRAWAL, Chappaqua, NY (US); Kailash GOPALAKRISHNAN, New York, NY (US); Hung Hoang TRAN, Chicago, IL (US); Vijayalakshmi SRINIVASAN, New York, NY (US)

(21) Appl. No.: 18/148,984

(22) Filed: Dec. 30, 2022

Related U.S. Application Data
(60) Provisional application No. 63/380,231, filed on Oct. 19, 2022.

(51) Int. Cl. G06F 7/483; G06F 7/544

(52) U.S. Cl. CPC G06F 7/483; G06F 7/5443

(57) ABSTRACT

Provided are a floating-point unit, a system, and method for generating binary integer output or floating-point output based on a selector. A first input operand, a second input operand, a third input operand, and a result format selector value are received. The first input operand, the second input operand, and the third input operand comprise floating-point values. The first input operand, the second input operand, and the third input operand are processed to produce a final result comprising one of a binary integer value and a floating point value based on the result format selector value.

### BACKGROUND

### Field of the Invention

Embodiments of the present invention relate to providing a floating-point unit with a Fused Multiply-Add (FMA) engine for generating binary integer output or floating-point output based on a selector.

### Description of the Related Art

Because computer memory is limited, it is not possible to store numbers with infinite precision, no matter whether the numbers use binary fractions or decimal fractions. At some point a number has to be cut off or rounded off to be represented in a computer memory.

How a number is represented in memory is dependent upon how much accuracy is desired from the representation. Generally, a single fixed way of representing numbers with binary bits is unsuitable for the varied applications where those numbers are used. A physicist needs to use numbers that represent the speed of light (about 300000000) as well as numbers that represent the Newton's gravitational constant (about 0.0000000000667), possibly together in some application.

To satisfy different types of applications and their respective needs for accuracy, a general-purpose number format has to be designed so that the format can provide accuracy for numbers at very different magnitudes. However, only relative accuracy is needed. For this reason, a fixed format of bits for representing numbers is not very useful. Floating-point representation solves this problem.

A floating-point representation resolves a given number into three main parts: (i) a significand that contains the number's digits, (ii) an exponent that sets the location where the decimal (or binary) point is placed relative to the beginning of the significand, and (iii) a sign (positive or negative) associated with the number. Negative exponents represent numbers that are very small (i.e. close to zero).

A Floating-Point Unit (FPU) is a processor or part of a processor, implemented as a hardware circuit, that performs floating-point calculations. While early FPUs were standalone processors, most are now integrated inside a computer's Central Processing Unit (CPU). Integrated FPUs in modern CPUs are very complex, since they perform high-precision floating-point computations while ensuring compliance with the rules governing these computations, as set forth in IEEE floating-point standards (IEEE 754).

An example floating-point operation is an FMA operation, which computes the product of two input floating-point operands and adds a third input floating-point operand to output a floating-point value.

Deep learning neural networks, also referred to as Deep Neural Networks (DNN) are a type of neural networks. The configuring and training of DNNs is computation intensive. Over the course of the training of a DNN, many floating-point computations have to be performed at each iteration, or cycle, of training. A DNN can include thousands if not millions of nodes. The number of floating-point computations required in the training of a DNN scales exponentially with the number of nodes in the DNN. Furthermore, different floating-point computations in the DNN training may potentially have to be precise to different numbers of decimal places.

Machine learning workloads tend to be computationally demanding. Training algorithms for popular deep learning benchmarks take weeks to converge on systems comprised of multiple processors. Specialized accelerators that can provide large throughput density for floating-point computations, both in terms of area (computation throughput per square millimeter of processor space) and power (computation throughput per watt of electrical power consumed), are important metrics for future deep learning systems.

### SUMMARY

Provided are a floating-point unit, a system, and method for generating binary integer output or floating-point output based on a selector. A first input operand, a second input operand, a third input operand, and a result format selector value are received. The first input operand, the second input operand, and the third input operand comprise floating-point values. The first input operand, the second input operand, and the third input operand are processed to produce a final result comprising one of a binary integer value and a floating point value based on the result format selector value.

### BRIEF DESCRIPTION OF THE SEVERAL VIEWS OF THE DRAWINGS

Referring now to the drawings in which like reference numbers represent corresponding parts throughout:

FIG. 1 illustrates, in a block diagram, a computing environment in accordance with certain embodiments.

FIG. 2 illustrates an Artificial Intelligence (AI) accelerator architecture and dataflow in accordance with certain embodiments.

FIG. 3 illustrates a set of instructions for an example Batch Normalization and Pack function in accordance with certain embodiments.

FIG. 4 illustrates an alternative set of instructions to those in FIG. 3 in accordance with certain embodiments.

FIG. 5A illustrates a floating-point fused multiply-add instruction in accordance with certain embodiments.

FIG. 5B illustrates a floating-point fused multiply-add instruction with a selector in accordance with certain embodiments.

FIG. 6 illustrates a hardware implementation of a floating-point unit that includes an FMA engine in accordance with certain embodiments.

FIG. 7 illustrates a 34-bit adder output of an FMA pipeline in accordance with certain embodiments.

FIG. 8 illustrates a modified 34-bit adder of an FMA pipeline in accordance with certain embodiments.

FIG. 9 illustrates a hardware implementation and data flow of a floating-point unit including an FMA engine in accordance with certain embodiments.

FIG. 10 illustrates another hardware implementation and data flow of a floating-point unit including an FMA engine in accordance with certain embodiments.

FIG. 11 illustrates, in a flowchart, operations for generating a binary integer result in accordance with certain embodiments.

FIG. 12 illustrates, in a flowchart, operations by a floating-point unit including an FMA engine in accordance with certain embodiments.

FIG. 13 illustrates a computing environment in accordance with certain embodiments.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments provide improved computer technology for implementing the fused multiply-add (“FMA”) engine to perform the multiply-add operation with input operands in floating-point values and an output of a binary integer value, as opposed to a floating-point value, to avoid having to perform the conversion in an additional operation after the fused multiply-add logic. In additional embodiments, the output may be a binary integer value or a floating-point value.

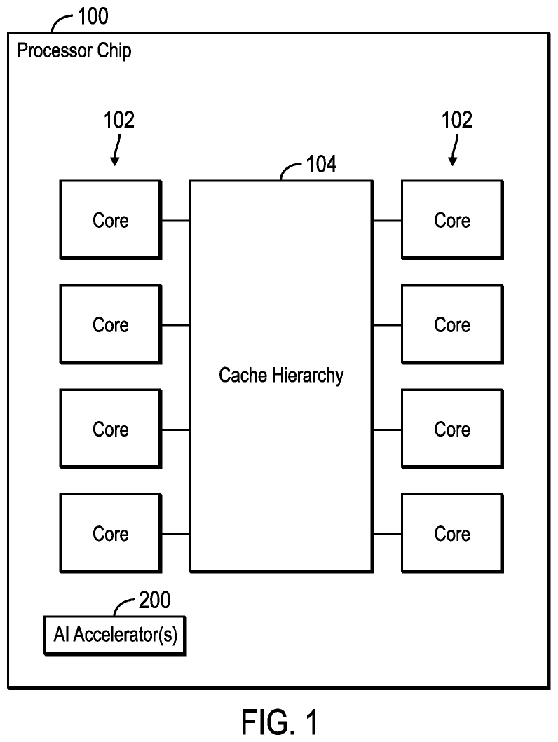

FIG. 1 illustrates an embodiment of a processor chip 100, such as an integrated circuit, having a plurality of cores 102 and a cache hierarchy 104 of memory shared by the cores 102. The processor chip 100 further includes one or more artificial intelligence (“AI”) accelerators 200. The processor chip 100 may be utilized in a server or enterprise machine to provide dedicated on-chip AI acceleration.

The AI accelerator 200 may be described as an on-chip AI accelerator 200 that enables generating real time insights from data as that data is getting processed. The AI accelerator 200 provides consistent low latency and high throughput (e.g., over 100 TFLOPS in 32 chip system) inference capacity usable by all threads. The AI accelerator 200 is memory coherent and directly connected to the fabric like other general-purpose core to support low latency inference while meeting the system's transaction rate. A scalable architecture providing transparent access to AI accelerator functions via a non-privileged general-purpose core instruction further reduces software orchestration and library complexity as well as provides extensibility to the AI functions.

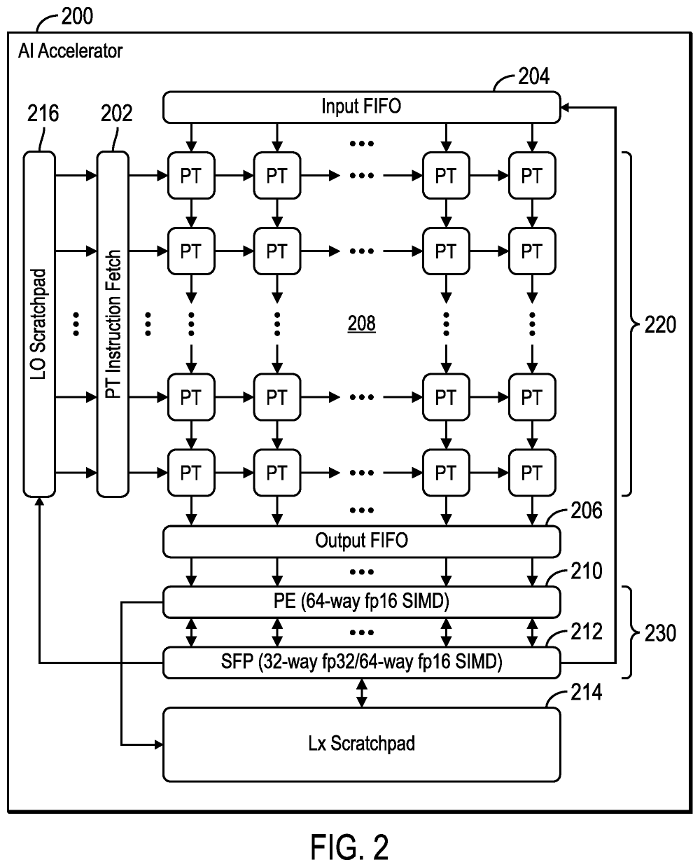

FIG. 2 illustrates an embodiment of the AI accelerator 200 architecture and dataflow in accordance with certain embodiments. The A1 accelerator 200 is designed to provide enough compute performance to keep up with the maximum sustained system data bandwidth for long running systolic operations, while the performance of concurrently running virtual machines or partitions is not noticeably affected. Furthermore, the design matches the peak on-chip data bandwidth for short running elementwise or activation AI functions, and hence gets the maximum possible speed up for these functions. The microarchitecture has two main components: the compute arrays and the PT instruction fetch.

FIG. 2 presents a block diagram of the AI accelerator 200 showing a processor tile (PT) instruction fetch 202, First In First Out (FIFO) input 204 and output 206 buffers, an array of Processor Tiles (PTs) 208, Processing Elements (PEs) 210, a Special Function Processor (SFP) 212, the Lx scratchpad 214, and the LO scratchpad 216.

The PT arrays 208 may comprise a two-dimensional compute fabric with integer computation engines, that perform performs multiply-accumulate operations on low-precision (INT4/INT8) weights and activations, and results are typically in INT16 format.

The PE 210 and SFP 212 comprises a one-dimensional compute row that accepts results from the compute fabric, and performs (a) outer loop summation/accumulations/scaling (in higher precision), (b) non-linear functions and (c) conversion back to low precision. As two-dimensional compute costs/latencies shrink and throughputs increase, the one-dimensional compute costs may become the bottlenecks.

The AI accelerator 200 may deliver more than 6 Teraflops (TFLOPS) (for FMA operations) per chip, which provides over 200 TFLOPS in the 22 chip system. The compute capacity comes from two separate compute arrays. Each compute array is specialized for certain types of AI operations, allowing for higher circuit customization and density as well as lower latency and power, since both compute arrays may not be in use. Discrete synchronization hardware and micro-instructions in the various engines allow for synchronization of the operations within the AI accelerator 200 and with the general purpose core that initiates the execution of Neural Network Processing Assist (NNPA) instructions.

The PT array 208, also called the matrix array, may consist of 128 Processor Tiles (PTs), which may be regarded as organized as 8 rows of 16 Processor Tiles each. Each row is elementwise connected to the row below. The top row if fed by the second compute array, allows data pre-processing on these inputs, and the bottom row returns results to the second compute array. A second stream of data is provided to the matrix array from the west side (via the LO scratchpad 216 and the PT Instruction Fetch 202) and ripples through a Processor Tile row to support efficient 2D-data computation. This compute array is used, for instance, to implement highly efficient matrix multiplication or convolution operations. Each Processor Tile implements an eight-way Single Instruction/Multiple Data (SIMD) engine optimized for multiply-accumulate operations. It contains a local register file sized to cover the pipeline depth of the engine and to store a subset of weights for some AI operations.

The second array is the data processing and activation array, which may consist of 32 processor tiles organized as two rows of 16 engines. One row may consist of engines named PEs 210. These PEs 210 may comprise 64-way FP16 (16-bit floating-point) SIMD engines focused on area and power efficient implementation for arithmetic, logical, look-up and type conversion functions and output to the Lx scratchpad 214 or the row of SFPs 212 below it. The other row consists of 16 engines named SFPs 212. The SFPs 212 may be a superset of the PEs 210. The SFPs 212 may comprise 32-way FP32/64-way FP16 SIMD. The SFP 212 also supports horizontal operations, such as shifting left/right across engines or computing a sum-across all elements of all SFP engines 212. This compute array may be used either exclusively for all non-systolic functions or for data preparation and gathering for systolic functions.

In certain embodiments, the AI accelerator 200 data flow starts with intelligent data prefetch, which loads data into the LO scratchpad 216 (e.g., a 512 KiloByte (KB) scratchpad). The LO scratchpad 216 may be organized in multiple sections to enable double-buffering of data and compute streams to allow overlapping of prefetching, compute and write-back phases to maximize parallelism within the accelerator and increase the overall performance. The translated physical addresses for input and output data are provided by the firmware running on the general purpose core. Data from the LO scratchpad 216 arrives at the PT compute engines 208 in the format and layout required by the AI operation executed. If needed, additional data manipulation is done by the complex function compute array (PE 210/SFP 212) before sending data to the PT compute engines 208 directly via the Input FIFO 204 or through the LO scratchpad 216. The results are collected from the Lx scratchpad 214 by the writeback engine and stored back to the caches 204 or memory.

In FIG. 2, bracket 220 represents PT tiles that are part of a 2D compute fabric with integer computation engines and which perform multiply-add operations on low-precision (INT4/INT8) weights and activations, with results that are typically in INT16 format. Also in FIG. 2, bracket 230 represents the PEs 210 and SFPs 212 that are part of the 1D compute row that accepts results from the compute fabric, and performs (a) outer loop summation/accumulations/scaling (in higher precision), (b) non-linear functions, and (c) conversion back to low precision.

With embodiments, as 2D compute costs/latencies shrink and throughputs increase, 1D compute may become the bottleneck.

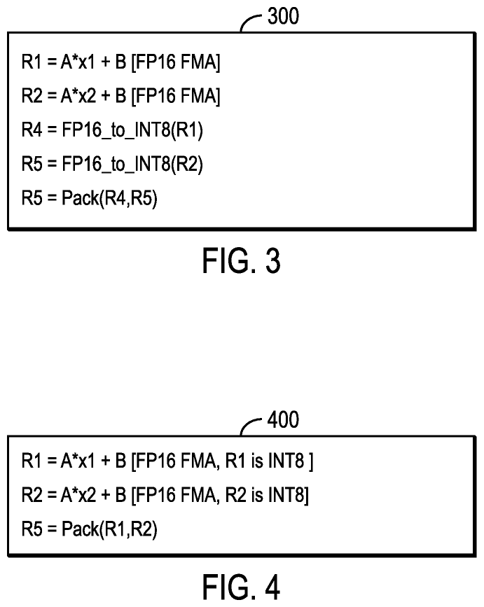

The final step in the PE is to convert the activations back to low-precision and pack the low-precision values into a tensor for prepping for next layer computation operations. FIG. 3 illustrates a set of instructions 300 for an example combined Batch Normalization and Pack function in accordance with certain embodiments. In FIG. 3, FMA instructions are used to scale and shift the X vector to perform Batch Normalization as well as best fit the low-precision range. Also, the set of instructions 300 include five instructions R1, R2, R3, R4, and R5, and these five instructions have bubbles and 3-cycle instruction latency, for a total latency of 13 cycles.

FIG. 4 illustrates an alternative set of instructions 400 to those in FIG. 3 in accordance with certain embodiments. In FIG. 4, the set of instructions 400 includes 3 instructions, with a total latency of 9 cycles.

Embodiments provide a new FMA instruction in the PE that produces INT8 results. In certain embodiments, INT8 may be described as a data type that stores whole numbers that can range in value from −128 to +127.

Embodiments provide a floating-point unit with a fused multiply-add engine that incorporates a floating-point fused multiply-add (or “multiply-accumulate”) instruction that accepts three floating-point inputs and produces a low-precision result in binary integer format.

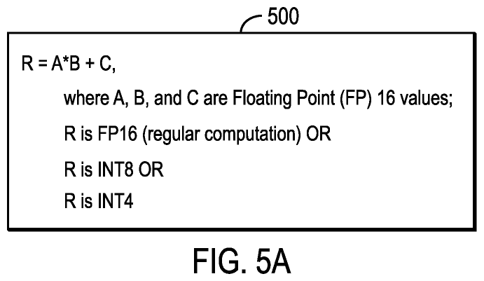

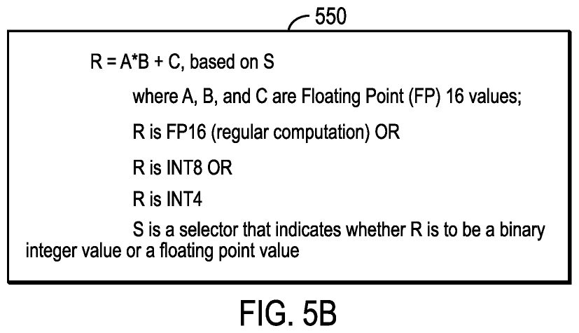

FIG. 5A illustrates a floating-point fused multiply-add instruction 500 in accordance with certain embodiments. With embodiments, an Instruction Set Architecture (ISA) supports the floating-point fused multiply-add instruction shown in FIG. 5. In the floating-point fused multiply-add instruction 500 (R=A*B+C), the three floating-point inputs are represented by A, B, and C, while the result is represented by R. In particular, A is one (“first”) multiplicand, B is the other (“second”) multiplicand, C is the addend, and R is the result. With the floating-point fused multiply-add instruction 500, the result R is a low-precision result in binary integer format.

FIG. 5B illustrates a floating-point fused multiply-add instruction with a selector 550 in accordance with certain embodiments. With embodiments, an Instruction Set Architecture (ISA) supports the floating-point fused multiply-add instruction shown in FIG. 5. In the floating-point fused multiply-add instruction 500 (R=A*B+C), based on S, the three floating-point inputs are represented by A, B, and C, while the result is represented by R. In particular, A is one (“first”) multiplicand, B is the other (“second”) multiplicand, C is the addend, and R is the result. With the floating-point fused multiply-add instruction 550, the selector S indicates whether the result R is to be a binary integer value or a floating point value.

In certain alternative embodiments, instead of having an instruction that includes the selector S, there are distinct instructions in the instruction set depending on the output (e.g., INT4, INT8, FP16, etc.), and the programmer/compiler chooses the appropriate instruction instead of setting the value of the selector S.

With embodiments, the result R may be floating-point (FP16) value, and INT8 value or an INT4 value. INT4 may be described as a data type that stores whole numbers that range in value from −8 to 7. Embodiments use sub-fields within the regular FMA instruction to signal the precision of the result, but distinct instructions in the ISA are also possible.

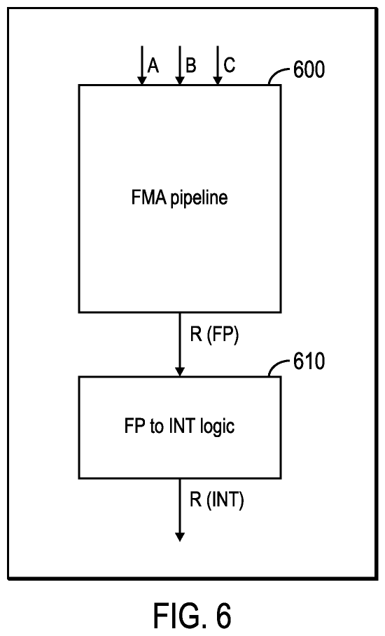

FIG. 6 illustrates a hardware implementation of a floating-point unit that includes an FMA engine in accordance with certain embodiments. In FIG. 6, the FMA pipeline 600 receives the three floating-point inputs A, B, and C and outputs R as a floating-point value. Then, this floating-point output R is input to an FP to INT logic block 610 that converts the floating-point value of R to a binary integer value of R and outputs that binary integer value of R. With embodiments, each FMA engine in the PE row (210) would have this additional FP to INT logic block 610.

Thus, in certain embodiments, the floating-point fused multiply-add instruction is implemented in hardware by adding the FP to INT logic block 610 following the FMA pipeline 600 that converts the floating-point result of the FMA pipeline 600 to a binary integer value in the target precision. With embodiments, the FP to INT logic block 610 adds logic depth, and subsequently additional latency and higher power consumption in the compute pipeline.

In certain embodiments, the FMA pipeline 600 has a normalizer and shifter logic block and a round/pack logic block, where the normalizer and shifter logic block accepts two inputs (a high-bit-precision mantissa from an adder, and an early exponent estimate from an Exponential (EXP) logic block) and produces the final mantissa and exponents of the result. In addition, the logic (shifter) in the normalizer and shifter logic block may be enhanced to produce binary integer results (as long as the target INT precision is narrower than the fraction of the floating-point result). The round/pack logic block performs rounding and packing.

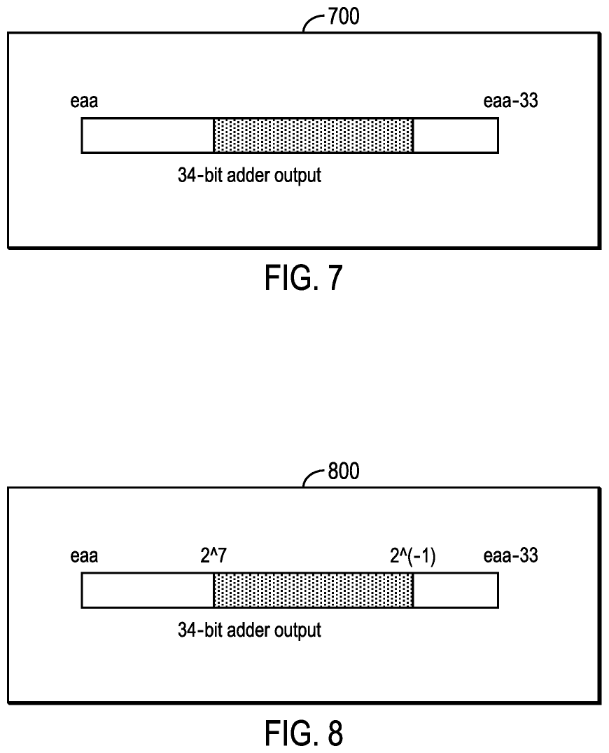

FIG. 7 illustrates a 34-bit adder 700 output of the FMA pipeline 600 in accordance with certain embodiments. For the 34-bit adder 700 output, operations performed in a Leading Zero Anticipator (LZA) logic block, the normalizer and shifter logic block, and the round/pack logic block are:
find the location of the leading 1 in the 34-bit word;
subtract that value from the early exponent estimate (eaa) to produce a result exponent;
pick out 11 mantissa bits out of the 34 bits in the normalizer and shifter logic block; and
round the 11 mantissa bits to 10 mantissa bits in the round/pack logic block.

FIG. 8 illustrates a modified 34-bit adder 800 of an FMA pipeline 600 in accordance with certain embodiments. For a 34-bit adder 800, operations performed in the LZA, the normalizer and shifter logic block, and the round/pack logic block are:
based on the early exponent estimate (eaa), pick out 9-bits from the adder output that correspond to [2\hat{ }7 . . . 2\hat{ }(−1)];
if the leading one is to the left of 2\hat{ }(7) position, saturate to +/−max;
if the leading one is to the right of 2\hat{ }(7) position, pick out corresponding bits; and
round the 9-bits to 8 in the round/pack logic block.

FIGS. 7 and 8 provide an example using 34 bits, however, in various embodiments, there may be fewer or more bits.

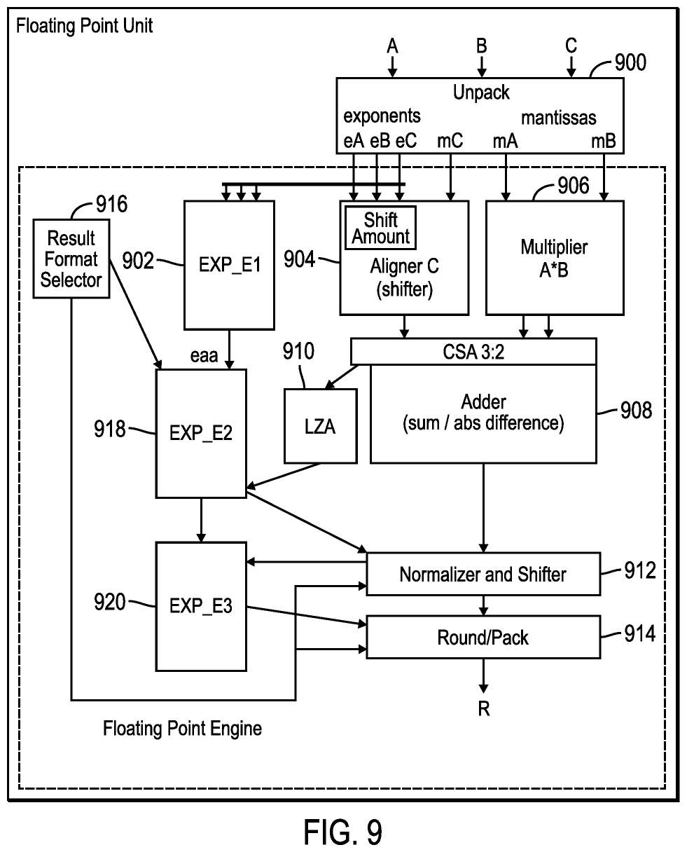

FIG. 9 illustrates a hardware implementation and data flow of a floating-point unit including an FMA engine in accordance with certain embodiments.

The FMA engine may operate according to the floating-point fused multiply-add instruction (R=A*B+C), based on S, where A is one (“first”) multiplicand, B is the other (“second”) multiplicand, C is the addend, R is the result, and S is a selector. These inputs A, B, and C may also be referred to as operands. With embodiments, A may be referred to as a first input operand, B may be referred to as a second input operand, and C may be referred to as a third input operand. The selector S is an input to the result forma selector 916. The result R may be referred to as the final result.

In FIG. 9, the unpack logic block 900 receives inputs of A, B, and C. The unpack logic block 900 formats and unpacks each input A, B, and C into its sign (i.e., positive (+) or negative (−)), exponents, and mantissa (i.e., significand) components. An exponent may be described as a component of a floating-point value that signifies the binary integer power to which a radix is raised in determining the value of that floating-point value. A mantissa may be described as part of a number in a floating-point format consisting of the significant digits. In particular, the unpack logic block 900 generates three exponents, an exponent for A (eA), an exponent for B (eB), and an exponent for C (eC). Also, the unpack logic block 900 generates three mantissas, a mantissa for A (mA), a mantissa for B (mB), and a mantissa for C (mC). The exponents eA, eB, and eC are input to an Exponential E1 (EXP_E1 or first exponential) logic block 902. The signs, mC and the exponents eA, eB, and eC are input to an aligner logic block 904. mA and mB are input to the multiplier logic block 906.

In certain embodiments, the amount of shift is ((eA+eB)−eC). The multiplier logic block 906 generates a product (A*B). The aligner logic block 904 properly aligns mC based on the shift amount to the product of the multiplier before the addend is added or combined with the product (A*B). The output of the aligner logic block 904, which is aligned C, and the output of the multiplier logic block 906 (where the output of the multiplier logic block 906 is in sum and carry redundant format) goes into an adder logic block 908 (i.e., a Carry Save Adder (CSA) logic block with n (3:2) counters in parallel).

The adder logic block 908 adds the aligned C to the product (A*B). The output of the adder logic block 908 is input to the LZA logic block 910 and the normalizer and shifter logic block 912. The output of the adder logic block 1008 may be referred to as an adder output or adder result.

The EXP_E1 logic block 902 outputs an early exponent estimate (eaa) to the EXP_E2 logic block 918. The LZA logic block 910 outputs a value of a position of a leading one in the output of the adder logic block 908. The output of the LZA logic block 910 is input to the Exponential E2 (EXP_E2 or second exponential) logic block 918. In addition, the result format selector logic block 916 outputs an indication of whether the result is to be in binary integer format or floating-point format. The output of the result format selector logic block 916 is input to the EXP_E2 logic block 918, the normalizer and shifter logic block 912, and the round/pack logic block 914.

The EXP_E2 logic block 918 computes the shift amount needed for normalizer and shifter logic block 912 and its output is input to the normalizer and shifter logic block 912 and to the Exponential E3 (EXP_E3 or third exponential) logic block 920.

When the floating-point unit including the FMA engine is instructed to produce a floating output, for example FP16, the EXP_E2 logic block 918 passes on the location of the LZA as the shift mount. When the floating-point unit including the FMA engine is instructed to produce a binary integer output, for example INT8, the EXP_E2 logic block 918 computes the difference between eaa and 7, and passes this value to the normalizer and shifter logic block 912. The EXP_E2 logic block 918 also uses the LZA logic block 910 output to compute if the final binary integer output of the FMA data path will exceed the maximum representable value, (in the case of INT8, −128 or 127), which is known as the overflow condition. This information is passed to the EXP_E3 logic block 920. That is, the overflow condition indicates that the desired output format (e.g., INT4, INT8, FP16, etc.) is not able to represent the result.

The output of the adder logic block 908 is the other input into the normalizer and shifter logic block 912. The normalizer and shifter logic block 912 picks out bits from the 34-bit adder output based on the shift amount and passes this to the round/pack logic block 914. In addition, the normalizer and shifter logic block 912 also passes a correction term (if needed) to the EXP_E3 logic block 920. Finally the round/pack logic shown block 914 uses the information signaled from EXP_E3 logic block 920 and the result format selector logic block 916 to produce a result R. The result R may be either a floating-point result during regular FMA computation mode, or a binary integer result (such as a 2's complement binary integer result) (or a +127/−128 result in case the EXP_E2 logic block 918 determines that the overflow condition is satisfied) during a binary integer result output mode of operation. If the result R is in a floating-point format, the floating-point format of result R may be different from the floating-point format of input A, B, and C. Thus, with embodiments, there is very low overhead for processing the floating-point fused multiply-add instruction.

With embodiments, the FMA pipeline 600 may be described as a conventional FMA engine and differs from the FMA engine of FIG. 9, where, for example, the FMA engine of FIG. 9 includes modified versions of logic blocks 918, 920, 912, and 914 and a new result format selector 916.

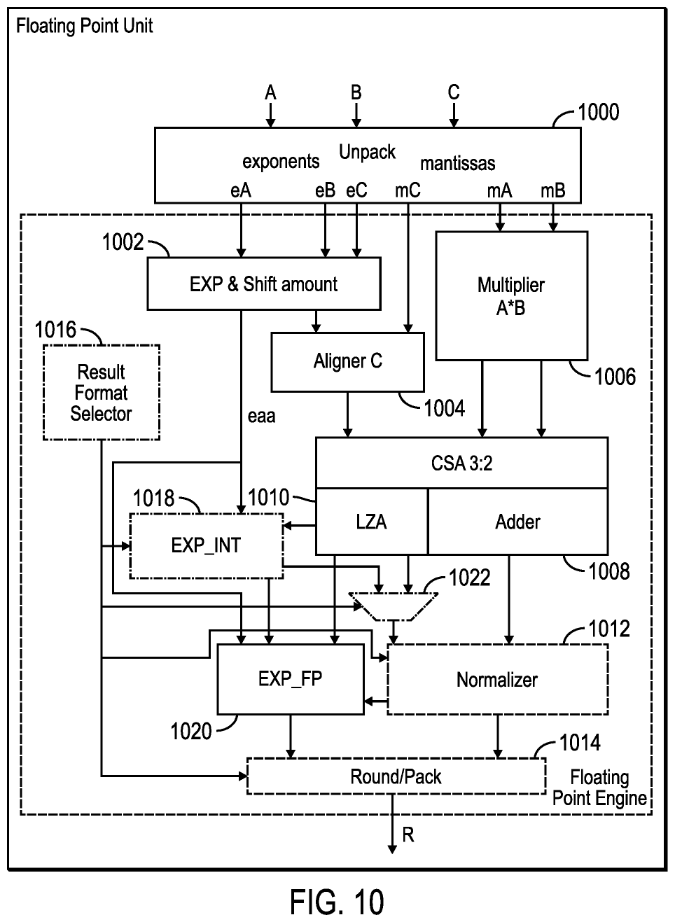

FIG. 10 illustrates another hardware implementation and data flow of a floating-point unit including an FMA engine in accordance with certain embodiments. In FIG. 10, logic blocks 1016, 1018, and 1022 are new blocks with reference to a conventional FMA engine, while logic blocks 1012 and 1014 have been modified with reference to a conventional FMA engine.

The FMA engine may operate according to the floating-point fused multiply-add instruction (R=A*B+C), based on S, where A is one (“first”) multiplicand, B is the other (“second”) multiplicand, C is the addend, R is the result, and S is a selector. These inputs A, B, and C may also be referred to as operands. With embodiments, A may be referred to as a first input operand, B may be referred to as a second input operand, and C may be referred to as a third input operand. The selector S is an input to the result forma selector 1016. The result R may be referred to as the final result.

In FIG. 10, the unpack logic block 1000 receives inputs of A, B, and C. The unpack logic block 1000 formats and unpacks each input A, B, and C into its sign (i.e., positive (+) or negative (−)), exponents, and mantissa (i.e., significand) components. An exponent may be described as a component of a floating-point value that signifies the binary integer power to which a radix is raised in determining the value of that floating-point value. A mantissa may be described as part of a number in a floating-point format consisting of the significant digits.

In particular, the unpack logic block 1000 generates three exponents, an exponent for A (eA), an exponent for B (eB), and an exponent for C (eC). Also, the unpack logic block 1000 generates three mantissas, a mantissa for A (mA), a mantissa for B (mB), and a mantissa for C (mC). The exponents eA, eB, and eC are input to an EXP & shift amount logic block 1002. The signs, mC, and the output of the EXP & shift amount logic block 1002 are the inputs to the aligner logic block 1004. mA and mB are input to the multiplier logic block 1006.

In certain embodiments, the amount of shift is ((eA+eB)−eC). The multiplier logic block 1006 generates a product (A*B). The aligner logic block 1004 properly aligns mC (based on the shift amount) to the product of the multiplier before the addend is added or combined with the product (A*B). The output of the aligner logic block 1004, which is aligned C, and the output of the multiplier logic block 1006 (where the output of the multiplier logic block 1006 is in sum and carry redundant format) goes into an adder logic block 1008 (i.e., a Carry Save Adder (CSA) logic block with n (3:2) counters in parallel).

The adder logic block 1008 adds the aligned C to the product (A*B). The output of the adder logic block 1008 is input to the LZA logic block 1010 and the normalizer logic block 1012. The output of the adder logic block 1008 may be referred to as an adder output or adder result.

The EXP & shift amount logic block 1002 outputs an early exponent estimate (eaa) to the Exponential Integer (EXP_INT, EXP_E2 or second exponential) logic block 1018 and to the Exponential Floating Point (EXP_FP, EXP_E3 or third exponential) logic block 1020. The LZA logic block 1010 outputs a value of a position of a leading one in the output of the adder logic block 1008, and this output of the LZA logic block 1010 is input to the EXP_INT logic block 1018, to the EXP_FP logic block 1020, and to the multiplexor (MUX) 1022. In addition, the result format selector logic block 1016 outputs an indication of whether the result is to be in binary integer format or floating-point format. The output of the result format selector logic block 1016 is input to the EXP_INT logic block 1018, the MUX 1022, the normalizer logic block 1012, and the round/pack logic block 1014.

The EXP_INT logic block 1018 computes the shift amount needed for the normalizer logic block 1012 and its output is input to the MUX 1022.

The MUX 1022 passes the shift amount value (e.g., a first shift amount value) from the EXP_INT logic block 1018 to the normalizer logic block 1012 when the result format is binary integer, and the value from the LZA logic block 1008 (which is another or a second shift amount value) to the normalizer logic block 1012 when the result is floating point.

When the floating-point unit including the FMA engine is instructed to produce a binary integer output, for example INT8, the EXP_INT logic block 1018 computes the difference between eaa and 7, and passes this value to the normalizer logic block 1012 via the MUX 1022. The EXP_INT logic block 1018 also uses the LZA logic block 1010 output to compute if the final binary integer output of the FMA data path will exceed the maximum representable value, (in the case of INT8, −128 or 127), which is known as the overflow condition. This information is passed to the EXP_FP logic block 1020.

The output of the adder logic block 1008 is the other input into the normalizer logic block 1012. The normalizer logic block 1012 picks out bits from the 34-bit adder output based on the shift amount and passes this to the round/pack logic block 1014. In addition, the normalizer logic block 1012 also passes a correction term (if needed) to the EXP_FP logic block 1020. Finally the round/pack logic shown block 1014 uses the information signaled from EXP_FP (1020) and the result format selector logic block 1016 to produce a result R.

With embodiments, the result R may be either a floating-point result during regular FMA computation mode, or a binary integer result (such as a 2's complement binary integer result) (or a +127/−128 result in case the EXP_INT logic block 1018 determined that the overflow condition is satisfied) during a binary integer result output mode of operation. If the result R is in a floating-point format, the floating-point format of result R may be different from the floating-point format of input A, B, and C. Thus, with embodiments, there is very low overhead for processing the floating-point fused multiply-add instruction.

With embodiments, a floating-point unit incorporating functionality to enable a fused-multiply-add instruction, comprises unpack logic to receive a first input operand, a second input operand, and a third input operand, wherein the first input operand, the second input operand, and the third input operand comprise floating-point values, and fused multiply-add logic to process the first input operand, the second input operand, and the third input operand to produce a binary integer value.

With embodiments, a floating-point unit incorporating functionality to enable a fused-multiply-add instruction, comprises unpack logic to receive a first input operand, a second input operand, and a third input operand, wherein the first input operand, the second input operand, and the third input operand comprise floating-point values, and fused multiply-add logic to process the first input operand, the second input operand, and the third input operand to produce one of a binary integer value and a floating point value.

Thus, embodiments provide a system for implementing a fused multiply-add operation in a computing environment. One or more hardware memories store executable instructions, which include an instruction including a first input operand, a second input operand, and a third input operand comprising floating-point numbers. A hardware processor includes a floating-point fused multiply-add engine include. The floating-point fused multiply-add engine includes: a result format selector logic block capable of outputting a result format selector value; a first exponential logic block capable of receiving data about the first input operand, the second input operand, and the third input operand and outputting an early exponent estimate (eaa); a second exponential logic block capable of receiving the result format selector value and outputting a shift amount in accordance with the result format selector value; a normalizer capable of shifting bits in a result value in accordance with the shift amount and in accordance with the result format selector value; third exponential logic block capable of providing information about an overflow condition; and round/pack logic block capable of rounding the result value in accordance with the information and in accordance with the result format selector value.

With embodiments, the floating-point unit includes: an unpack logic block capable of formatting and unpacking the first input operand, the second input operand, and the third input operand and an FMA engine, where the FMA engine includes a multiplier logic block capable of multiplying the first input operand and the second input operand to generate a product; and an aligner logic block capable of aligning the third input operand to the product of the multiplier.

With embodiments, the FMA engine includes: an adder logic block capable of adding the third input operand to the product of the multiplier to generate the result and a Leading Zero Anticipator (LZA) logic block capable of outputting a number of leading zero bits in the result.

With embodiments of this system, the result format selector allows selection of a format from a group comprising: one or more binary integer formats and one or more floating-point formats. With embodiments of this system, the result format selector value is derived from a sub-field of an FMA instruction. With embodiments of this system, the result format selector value is obtained by decoding opcode FMA instructions in an Instruction Set Architecture (ISA), wherein there are distinct opcodes based on the selected format of the result.

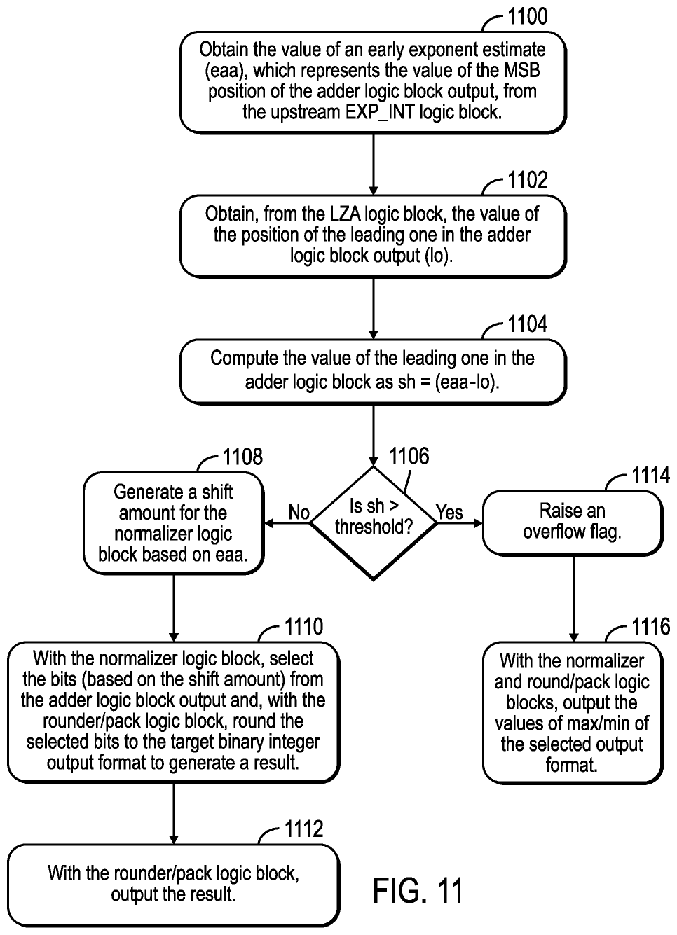

FIG. 11 illustrates, in a flowchart, operations for generating a binary integer result in accordance with certain embodiments. Control begins at block 1100 with the EXP_INT logic block 1018 obtaining the value of an early exponent estimate (eaa), which represents the value of the Most Significant Bit (MSB) position of the adder logic block 1002 output, from the upstream EXP_INT logic block 1018. In block 1102, the EXP_INT logic block 1018 obtains a value of a position of a leading one in the adder output (lo) from the LZA logic block 1010. In block 1104, the EXP_INT logic block 1018 computes the value of the leading one in the adder logic block 1008 as sh=(eaa−lo). In certain embodiments, eaa may be referred to as a first value, and lo may be referred to as a second value.

In block 1106, the EXP_INT logic block 1018 determines whether the value of sh exceeds a threshold. If not, processing continues to block 1108, otherwise, processing continues to block 1114. With embodiments, the threshold may be determined by the bit-width/format of the floating point inputs, as well as, the bit-width of the integer output. In block 1108, the EXP_INT logic block 1018 generates a shift amount for the normalizer block 1012 based on eaa. In block 1110, the normalizer logic block selects bits (based on the shift amount) from the adder logic block 1008 output, and the rounder/pack logic block 1014 rounds the selected bits to the target binary integer output format (e.g., INT4 or INT8) to generate a result. In block 1112, the rounder/pack logic block 1014 outputs the result.

In block 1114, the EXP_INT logic block 1018 raises an overflow flag. In block 1116, the normalizer logic block 1012 and the round/pack logic block 1014 outputs a maximum value and a minimum value (min/max values) supported by the output format (e.g., INT4, INT8, FP16, etc.) of the result. For example, for INT8, max/min=+128/−127.

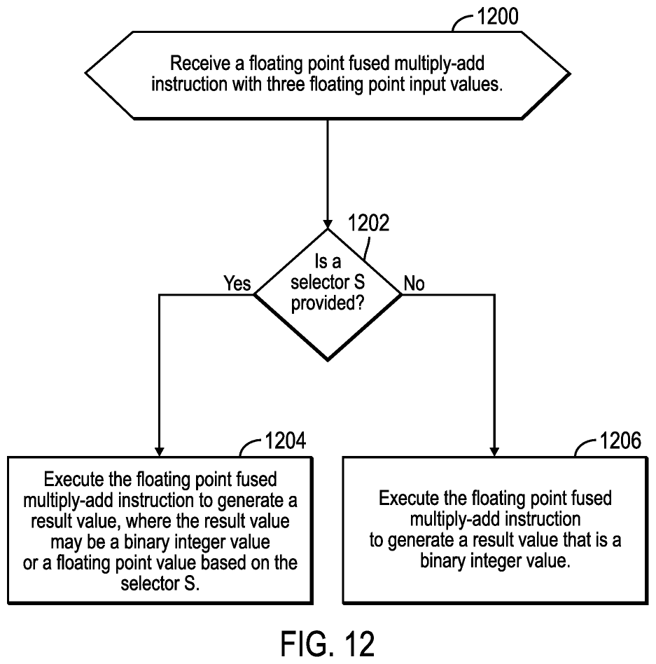

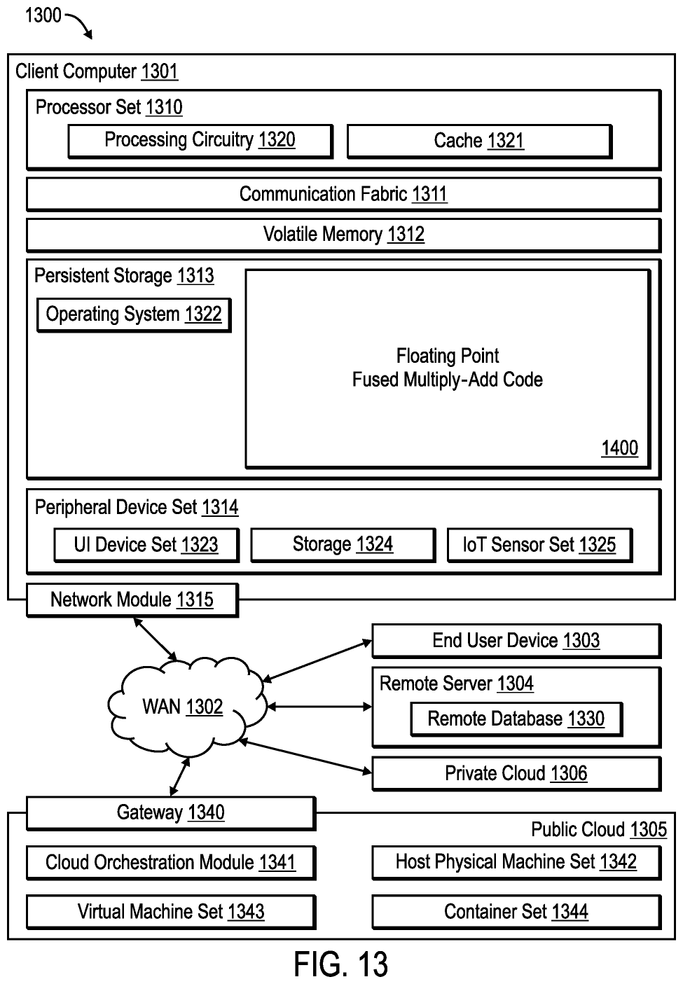

FIG. 12 illustrates, in a flowchart, operations by a floating-point unit including an FMA engine in accordance with certain embodiments. Control begins at block 1200 with the fused multiply-add code 1400 (of FIG. 13) receiving a floating-point fused multiply-add instruction with three floating-point input values. In block 1202, the fused multiply-add code 1200 determining whether the instruction includes a selector S. If so, processing continues to block 1204, otherwise, processing continues to block 1206. In block 1204, the fused multiply-add code 1400 (of FIG. 13) executes the floating-point fused multiply-add instruction to generate a result value, which may be a binary integer value (in a binary integer format) or a floating-point value (in a floating-point format) based on the selector S. In block 1206, the fused multiply-add code 1200 executes the floating-point fused multiply-add instruction to generate a result value that is a binary integer value. With embodiments, the execution is performed by the floating-point unit including the FMA engine.

In certain embodiments, a floating point unit with an FMA engine may be implemented in a PE 210 and/or in an SFP 212.

Embodiments provide a method by a processor, for implementing a fused multiply-add operation in a computing environment that performs: receiving an instruction stored in a memory, wherein the instruction contains three inputs comprising floating-point numbers; and executing the instruction by: obtaining a result format selector value; receiving data about the first input operand, the second input operand, and the third input operand and outputting an early exponent estimate (eaa); receiving the result format selector value and outputting a shift amount in accordance with the result format selector value; shifting bits in a result value in accordance with the shift amount and in accordance with the result format selector value; providing information about an overflow condition; and rounding the result value in accordance with the information and in accordance with the result format selector value.

With embodiments, the method also performs formatting and unpacking the first input operand, the second input operand, and the third input operand; multiplying the first input operand and the second input operand to generate a product; and aligning the third input operand to the product of the multiplier.

With embodiments, the method performs adding the third input operand to the product of the multiplier to generate the result and outputting a number of leading zero bits in the result.

With embodiments of this method, the result format selector value is selected from a group comprising: one or more binary integer formats and one or more floating-point formats. With embodiments of this method, the result format selector value is derived from a sub-field of an FMA instruction. With embodiments of this method, the result format selector value is obtained by decoding opcode FMA instructions in an Instruction Set Architecture (ISA), wherein there are distinct opcodes based on the selected format of the result.

Embodiments provide a floating-point unit that incorporates a Fused Multiply-Add (FMA) instruction that accepts three floating-point inputs and produces a low-precision result in binary integer format. In addition, embodiments provide an efficient hardware implementation by restricting the target binary integer format to be narrower than the fractional part of the standard FMA result format. This allows for a low-overhead way of providing choices to a programmer (i.e., the FMA engine is capable of producing the result in floating-point as well as multiple low-precision binary integer formats).

Embodiments natively produce a binary integer output from a floating-point pipeline, which helps speed up certain programs that would otherwise require dedicated instructions to convert from floating-point to binary integer (two's complement) format.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 13 illustrates a computing environment 1300 in accordance with certain embodiments. Computing environment 1300 contains an example of an environment for the execution of at least some of the computer code involved in performing the inventive methods, such as floating-point fused multiply-add code 1400, which interacts with the AI accelerator 200 for deep learning neural network operations. In addition to block 1400, computing environment 1300 includes, for example, computer 1301, wide area network (WAN) 1302, end user device (EUD) 1303, remote server 1304, public cloud 1305, and private cloud 1306. In this embodiment, computer 1301 includes processor set 1310 (including processing circuitry 1320 and cache 1321), communication fabric 1311, volatile memory 1312, persistent storage 1313 (including operating system 1322 and block 1400, as identified above), peripheral device set 1314 (including user interface (UI) device set 1323, storage 1324, and Internet of Things (IoT) sensor set 1325), and network module 1315. Remote server 1304 includes remote database 1330. Public cloud 1305 includes gateway 1340, cloud orchestration module 1341, host physical machine set 1342, virtual machine set 1343, and container set 1344. In certain embodiments, for the processor set 1310, such as the processor chip 100, the processing circuitry 1320 may include the AI accelerator 200 of FIGS. 1 and 2.

COMPUTER 1301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1330. As is well understood in the art of computer technology, and depending upon the technology, performance of a computer-implemented method may be distributed among multiple computers and/or between multiple locations. On the other hand, in this presentation of computing environment 1300, detailed discussion is focused on a single computer, specifically computer 1301, to keep the presentation as simple as possible. Computer 1301 may be located in a cloud, even though it is not shown in a cloud in FIG. 13. On the other hand, computer 1301 is not required to be in a cloud except to any extent as may be affirmatively indicated.

PROCESSOR SET 1310 includes one, or more, computer processors of any type now known or to be developed in the future. Processing circuitry 1320 may be distributed over multiple packages, for example, multiple, coordinated integrated circuit chips. Processing circuitry 1320 may implement multiple processor threads and/or multiple processor cores. Cache 1321 is memory that is located in the processor chip package(s) and is typically used for data or code that should be available for rapid access by the threads or cores running on processor set 1310. Cache memories are typically organized into multiple levels depending upon relative proximity to the processing circuitry. Alternatively, some, or all, of the cache for the processor set may be located “off chip.” In some computing environments, processor set 1310 may be designed for working with qubits and performing quantum computing.

Computer readable program instructions are typically loaded onto computer 1301 to cause a series of operational steps to be performed by processor set 1310 of computer 1301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1321 and the other storage media discussed below. The program instructions, and associated data, are accessed by processor set 1310 to control and direct performance of the inventive methods. In computing environment 1300, at least some of the instructions for performing the inventive methods may be stored in block 1400 in persistent storage 1313.

COMMUNICATION FABRIC 1311 is the signal conduction path that allows the various components of computer 1301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1312 is any type of volatile memory now known or to be developed in the future. Examples include dynamic type random access memory (RAM) or static type RAM. Typically, volatile memory 1312 is characterized by random access, but this is not required unless affirmatively indicated. In computer 1301, the volatile memory 1312 is located in a single package and is internal to computer 1301, but, alternatively or additionally, the volatile memory may be distributed over multiple packages and/or located externally with respect to computer 1301.

PERSISTENT STORAGE 1313 is any form of non-volatile storage for computers that is now known or to be developed in the future. The non-volatility of this storage means that the stored data is maintained regardless of whether power is being supplied to computer 1301 and/or directly to persistent storage 1313. Persistent storage 1313 may be a read only memory (ROM), but typically at least a portion of the persistent storage allows writing of data, deletion of data and re-writing of data. Some familiar forms of persistent storage include magnetic disks and solid state storage devices. Operating system 1322 may take several forms, such as various known proprietary operating systems or open source Portable Operating System Interface-type operating systems that employ a kernel. The code included in block 1400 typically includes at least some of the computer code involved in performing the inventive methods.

PERIPHERAL DEVICE SET 1314 includes the set of peripheral devices of computer 1301. Data communication connections between the peripheral devices and the other components of computer 1301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1323 may include components such as a display screen, speaker, microphone, wearable devices (such as goggles and smart watches), keyboard, mouse, printer, touchpad, game controllers, and haptic devices. Storage 1324 is external storage, such as an external hard drive, or insertable storage, such as an SD card. Storage 1324 may be persistent and/or volatile. In some embodiments, storage 1324 may take the form of a quantum computing storage device for storing data in the form of qubits. In embodiments where computer 1301 is required to have a large amount of storage (for example, where computer 1301 locally stores and manages a large database) then this storage may be provided by peripheral storage devices designed for storing very large amounts of data, such as a storage area network (SAN) that is shared by multiple, geographically distributed computers. IoT sensor set 1325 is made up of sensors that can be used in Internet of Things applications. For example, one sensor may be a thermometer and another sensor may be a motion detector.

NETWORK MODULE 1315 is the collection of computer software, hardware, and firmware that allows computer 1301 to communicate with other computers through WAN 1302. Network module 1315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1315 are performed on the same physical hardware device. In other embodiments (for example, embodiments that utilize software-defined networking (SDN)), the control functions and the forwarding functions of network module 1315 are performed on physically separate devices, such that the control functions manage several different network hardware devices. Computer readable program instructions for performing the inventive methods can typically be downloaded to computer 1301 from an external computer or external storage device through a network adapter card or network interface included in network module 1315.

WAN 1302 is any wide area network (for example, the internet) capable of communicating computer data over non-local distances by any technology for communicating computer data, now known or to be developed in the future. In some embodiments, the WAN 1302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1303 is any computer system that is used and controlled by an end user (for example, a customer of an enterprise that operates computer 1301), and may take any of the forms discussed above in connection with computer 1301. EUD 1303 typically receives helpful and useful data from the operations of computer 1301. For example, in a hypothetical case where computer 1301 is designed to provide a recommendation to an end user, this recommendation would typically be communicated from network module 1315 of computer 1301 through WAN 1302 to EUD 1303. In this way, EUD 1303 can display, or otherwise present, the recommendation to an end user. In some embodiments, EUD 1303 may be a client device, such as thin client, heavy client, mainframe computer, desktop computer and so on.

REMOTE SERVER 1304 is any computer system that serves at least some data and/or functionality to computer 1301. Remote server 1304 may be controlled and used by the same entity that operates computer 1301. Remote server 1304 represents the machine(s) that collect and store helpful and useful data for use by other computers, such as computer 1301. For example, in a hypothetical case where computer 1301 is designed and programmed to provide a recommendation based on historical data, then this historical data may be provided to computer 1301 from remote database 1330 of remote server 1304.

PUBLIC CLOUD 1305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1305 is performed by the computer hardware and/or software of cloud orchestration module 1341. The computing resources provided by public cloud 1305 are typically implemented by virtual computing environments that run on various computers making up the computers of host physical machine set 1342, which is the universe of physical computers in and/or available to public cloud 1305. The virtual computing environments (VCEs) typically take the form of virtual machines from virtual machine set 1343 and/or containers from container set 1344. It is understood that these VCEs may be stored as images and may be transferred among and between the various physical machine hosts, either as images or after instantiation of the VCE. Cloud orchestration module 1341 manages the transfer and storage of images, deploys new instantiations of VCEs and manages active instantiations of VCE deployments. Gateway 1340 is the collection of computer software, hardware, and firmware that allows public cloud 1305 to communicate through WAN 1302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1306 is similar to public cloud 1305, except that the computing resources are only available for use by a single enterprise. While private cloud 1306 is depicted as being in communication with WAN 1302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1305 and private cloud 1306 are both part of a larger hybrid cloud.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

In the described embodiment, variables a, b, c, i, n, m, p, r, etc., when used with different elements may denote a same or different instance of that element.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, embodiments of the invention reside in the claims herein after appended. The foregoing description provides examples of embodiments of the invention, and variations and substitutions may be made in other embodiments.

What is claimed is:

1. A floating-point unit incorporating functionality to enable a fused-multiply-add instruction, comprising:
logic to receive a first input operand, a second input operand, a third input operand, and a result format selector value, wherein the first input operand, the second input operand, and the third input operand comprise floating-point values; and
fused multiply-add logic to process the first input operand, the second input operand, and the third input operand to produce a final result comprising one of a binary integer value and a floating point value based on the result format selector value.

2. The floating-point unit incorporating functionality to enable the fused-multiply-add instruction of claim 1, wherein the fused multiply-add logic comprises:
inputting the result selector format value to a multiplexor, wherein the multiplexor passes a first shift amount in response to the result selector format value indicating that the final result is to be the binary integer value, and wherein the multiplexor passes a second shift amount in response to the result selector format value indicating that the final result is to be the floating point value.

3. The floating-point unit incorporating functionality to enable the fused-multiply-add instruction of claim 2, wherein the fused multiply-add logic comprises:
in response to receiving the first shift amount, generating the binary integer value as the final result; and
in response to receiving the second shift amount, generating the floating point value as the final result.

4. The floating-point unit incorporating functionality to enable the fused-multiply-add instruction of claim 2, wherein the fused multiply-add logic comprises:
receiving a first exponent for the first input operand, a second exponent for the second input operand, and a third exponent for the third input operand; and
generating an early exponent estimate and a third shift amount for the third input operand.

5. The floating-point unit incorporating functionality to enable the fused-multiply-add instruction of claim 4, wherein the fused multiply-add logic comprises:
multiplying the first input operand and the second input operand to generate a product;
aligning the third input operand to the product; and
adding the product and the aligned third input operand to generate an adder output.

6. The floating-point unit incorporating functionality to enable the fused-multiply-add instruction of claim 5, wherein the fused multiply-add logic comprises:
generating the first shift amount based on the early exponent estimate, the adder output, and the result format selector value.

7. The floating-point unit incorporating functionality to enable the fused-multiply-add instruction of claim 6, wherein the fused multiply-add logic comprises:
generating the second shift amount based on the adder output.

8. The floating-point unit incorporating functionality to enable the fused-multiply-add instruction of claim 6, wherein the fused multiply-add logic comprises:
raising an overflow flag; and
outputting a maximum value and a minimum value based on an output format for the final result.

9. A system, comprising:
a plurality of processing cores;
a cache memory; and
a plurality of artificial intelligence accelerators that produce artificial intelligence processing results to return to the cache memory for processing by the processing cores, wherein each of the plurality of artificial intelligence accelerators include a plurality of floating-point units incorporating functionality to enable a fused multiply-add instruction, wherein a floating-point unit of the plurality of floating-point units comprises:
logic to receive a first input operand, a second input operand, a third input operand, and a result format selector value, wherein the first input operand, the second input operand, and the third input operand comprise floating-point values; and
fused multiply-add logic to process the first input operand, the second input operand, and the third input operand to produce a final result comprising one of a binary integer value and a floating point value based on the result format selector value.

10. The system of claim 9, wherein the fused multiply-add logic further performs:
inputting the result selector format value to a multiplexor, wherein the multiplexor passes a first shift amount in response to the result selector format value indicating that the final result is to be the binary integer value, and wherein the multiplexor passes a second shift amount in response to the result selector format value indicating that the final result is to be the floating point value.

11. The system of claim 10, wherein the fused multiply-add logic further performs:
in response to receiving the first shift amount, generating the binary integer value as the final result; and
in response to receiving the second shift amount, generating the floating point value as the final result.

12. The system of claim 11, wherein the fused multiply-add logic further performs:
receiving a first exponent for the first input operand, a second exponent for the second input operand, and a third exponent for the third input operand; and
generating an early exponent estimate and a shift amount for the third input operand.

13. The system of claim 12, wherein the fused multiply-add logic further performs:
multiplying the first input operand and the second input operand to generate a product;
aligning the third input operand to the product; and
adding the product and the aligned third input operand to generate an adder output.

14. The system of claim 13, wherein the fused multiply-add logic further performs:
generating the first shift amount based on the early exponent estimate, the adder output, and the result format selector value.

15. A method for processing a fused multiply-add operation, comprising:
receiving a first input operand, a second input operand, a third input operand, and a result format selector value, wherein the first input operand, the second input operand, and the third input operand comprise floating-point values; and
processing the first input operand, the second input operand, and the third input operand to produce a final result comprising one of a binary integer value and a floating point value based on the result format selector value.

16. The method of claim 15, further comprising:
inputting the result selector format value to a multiplexor, wherein the multiplexor passes a first shift amount in response to the result selector format value indicating that the final result is to be the binary integer value, and wherein the multiplexor passes a second shift amount in response to the result selector format value indicating that the final result is to be the floating point value.

17. The method of claim 16, further comprising:
in response to receiving the first shift amount, generating the binary integer value as the final result; and
in response to receiving the second shift amount, generating the floating point value as the final result.

18. The method of claim 16, further comprising:
receiving a first exponent for the first input operand, a second exponent for the second input operand, and a third exponent for the third input operand; and
generating an early exponent estimate and a shift amount for the third input operand.

19. The method of claim 18, further comprising:
multiplying the first input operand and the second input operand to generate a product;
aligning the third input operand to the product; and
adding the product and the aligned third input operand to generate an adder output.

20. The method of claim 19, further comprising:
generating the first shift amount based on the early exponent estimate, the adder output, and the result format selector value.
